(19) United States
(12) Patent Application Publication
(10) Pub. No.: US 2025/0066236 A1
(43) Pub. Date: Feb. 27, 2025

(54) MOLTEN GLASS TRANSPORT SYSTEMS AND METHODS

(71) Applicant: Owens-Brockway Glass Container Inc., Perrysburg, OH (US)

(72) Inventors: Jason Pickles, Adrian, MI (US); Stephen M. Graff, Maumee, OH (US); Karl Johnston, Perrysburg, OH (US); Thomas Kirkman, Perrysburg, OH (US); Charles Obee, Monclova, OH (US); Brian Brozell, Maumee, OH (US)

(21) Appl. No.: 18/455,599

(22) Filed: Aug. 24, 2023

(51) Int. Cl. C03B 7/14

(52) U.S. Cl. CPC C03B 7/14

(57) ABSTRACT

A molten glass transport system includes rails spaced laterally apart from one another and establishing a cup transport path and cup carriages suspended from the rails and movable back and forth along the cup transport path of the rails. A related method and glass manufacturing system are also disclosed.

### TECHNICAL FIELD

This patent application discloses innovations related to glass manufacturing and, more particularly, to the transportation of molten glass to forming machines that are configured to form the molten glass into glass articles.

### BACKGROUND

Glass containers are formed from gobs of molten glass that may have to be delivered to container forming equipment. Various avenues exist for melting a batch of vitrifiable material (a “glass batch”) into molten glass and creating the molten glass gobs. For example, the glass batch may be fed onto a relatively calm molten glass bath in a conventional continuously-operated furnace and melted into molten glass using radiant heat from overhead burners that discharge hot combustion gases into a combustion zone above the glass bath. As another example, the glass batch may fed into a turbulent glass melt contained a submerged combustion melter (SCM) and melted into molten glass by directly discharging hot combustion gases into the glass melt through floor or wall mounted submerged burners. In either case, the produced molten glass is fined and/or refined to remove entrained gas bubbles from the glass, and is supplied to a forehearth. Within the forehearth, the substantially bubble-free molten glass is conditioned to a more uniform viscosity suitable for downstream forming operations.

At a downstream end of the forehearth, a molten glass feeder receives molten glass flowing horizontally from the forehearth, produces a vertical flow of molten glass, and cuts the vertical flow of molten glass into glass gobs that freefall into gob handling equipment. The gob handling equipment typically includes a lengthy series of distributors, scoops, chutes, troughs, deflectors, and funnels. The gob handling equipment directs the glass gobs to chute-fed glass forming machines that form the gobs into finished glass articles such as hollow containers. Each of the forming machines includes a blank mold and a blow mold that are operated together. In the blank mold, a glass gob is pressed or blown into a partially-formed container or parison. The parison is then inverted, transferred to the blow mold, and blown into a finished container within the blow mold. While the conventional process of delivering molten glass into the blank molds of the forming machines is practical and workable, the equipment needed to perform that function is relatively tall, takes up considerable space, and has a tendency to deliver glass gobs with significantly varying characteristics-such as varying delivery times, circumferential temperature non-uniformities, and/or friction-dependent shape variations-to the blank molds.

### SUMMARY OF THE DISCLOSURE

The present disclosure embodies a number of aspects that can be implemented separately from or in combination with each other.

An embodiment of a method for transporting molten glass, includes (a) moving a first cup carriage along a cup transport path between spaced apart rails to a common loading position below a glass feeder, wherein the first cup carriage includes a first transport cup; (b) receiving molten glass from the glass feeder along a feeder axis between the rails into the first transport cup of the first cup carriage; (c) moving the first cup carriage to a first unloading position along the cup transport path to locate the first transport cup over a first blank mold having a first blank mold loading axis; and (d) dispensing the molten glass between the rails from the first transport cup into the first blank mold along the first blank mold loading axis.

An embodiment of a glass manufacturing system includes a glass forming system, including glass forming machines arranged adjacent to one another, and each including blank molds having blank mold loading axes, and blow molds spaced apart from the blank molds. The glass manufacturing system also includes a molten glass handling system including a glass feeder to feed molten glass along one or more feeder axes offset from the blank mold loading axes, and a molten glass transport system to transport the molten glass to the blank molds of the glass forming machines of the glass forming system. The molten glass transport system includes rails spaced laterally apart from one another and establishing a cup transport path, and cup carriages extending laterally between the rails and movable back and forth along the cup transport path between, to, and from the one or more feeder axes and the blank mold loading axes, and including one or more transport cups to receive the molten glass from the glass feeder along the one or more feeder axes and dispense the molten glass to the blank molds along the blank mold loading axes.

An embodiment of a molten glass transport system includes rails spaced laterally apart from one another and establishing a cup transport path, and cup carriages movable back and forth along the cup transport path of the rails. The cup carriages includes carriage carts translatably coupled to the rails, carriage frames extending laterally between the rails and coupled to the carriage carts, and transport cups carried by the carriage frames.

Another embodiment of a molten glass transport system includes a gantry, including gantry rails spaced laterally apart and establishing a cup transport path, gantry cross-members spaced apart and extending transversely to the cup transport path and extending between and coupled to the gantry rails, and drivetrains. The system also includes cup carriages carried by the gantry and movable along the cup transport path on the rails, and including carriage carts spaced laterally apart and coupled to the rails, carriage frames coupled to and extending between the carriage carts, and transport cups carried by the carriage frames.

A further embodiment of a molten glass transport system includes rails spaced laterally apart from one another and establishing a cup transport path, and cup carriages suspended from the rails and movable back and forth along the cup transport path of the rails.

### BRIEF DESCRIPTION OF THE DRAWINGS

FIG. 1 is a perspective view of a glass manufacturing system including a molten glass transport system in accordance with an illustrative embodiment of the present disclosure;

FIG. 2 is an enlarged perspective view of the molten glass transport system of FIG. 1;

FIG. 3 is another enlarged perspective view of the molten glass transport system of FIG. 1, taken from a different perspective;

FIG. 4 is an enlarged fragmentary cross-sectional view of a portion of the molten glass transport system of FIG. 2, taken from lines 4-4 of FIG. 2, and illustrating drive belts located below a rail of the system;

FIG. 5 is an enlarged fragmentary view of a portion of the molten glass transport system of FIG. 2, with the rail removed to illustrate the drive belts and belt couplings;

FIG. 6 is a top view of a gantry of the molten glass transport system of FIG. 2;

FIG. 7 is a side view of the gantry of FIG. 6;

FIG. 8 is an enlarged end view of the gantry of FIG. 6;

FIG. 9 is a top view of the molten glass transport system of FIG. 2, illustrating the gantry in a production position;

FIG. 10 is a top view of the molten glass transport system of FIG. 2, illustrating the gantry in a parked position;

FIG. 11 is a perspective view of a glass manufacturing system including a molten glass transport system in accordance with another illustrative embodiment of the present disclosure; and

FIG. 12 is an enlarged fragmentary perspective view of a portion of the glass manufacturing system of FIG. 11.

### DETAILED DESCRIPTION

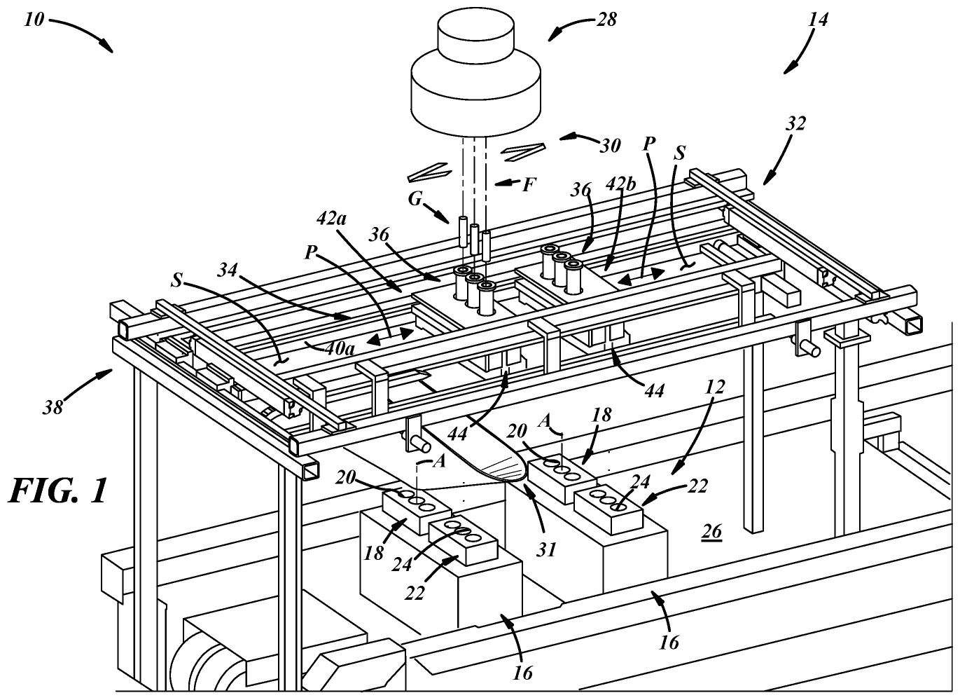

A molten glass transport system is described below with reference to its use between a glass feeder and an individual section (IS) machine used to produce glass containers. The molten glass transport system may of course be used between a glass feeder and any other type(s) of equipment for producing glass products while maintaining the same or similar functionality. With specific reference now to the drawing figures, FIG. 1 illustrates a glass manufacturing system 10 shown schematically in accordance with an illustrative embodiment of the present disclosure. The glass manufacturing system 10 comprises a glass forming system 12 and a molten glass handling system 14. The molten glass handling system 14 receives molten glass from a furnace, forehearth, or other glass-containing vessel, and transports discrete portions of molten glass G to the glass forming system 12. The terminology “discrete portion of molten glass” encompasses any defined quantity of molten glass including a molten glass gob, gather, distribution from a continuous stream, chunk, or charge.

The glass forming system 12 includes one or more forming machines 16. Each of the forming machines 16 includes a blank side 18 having one or more blank molds 20 that individually and repeatedly receives a discrete portion of molten glass G time from the molten glass handling system 14 and forms the portion of molten glass G into glass parisons (not shown). Each of the forming machines 16 also includes a blow side 22 having one or more blow molds 24, which receive the parison(s) from the one or more blank molds 20 and form the parison(s) into finished glass articles. The forming machines 16 may be individual sections of an overall individual section (IS) machine that forms glass containers. Openings of the blank molds 20 are centered about respective blank mold loading axes A. The molten glass handling system 14 is configured to deliver the molten glass portions G into each of the blank molds 20 along the blank mold loading axes A. Each blank mold 20 is configured to shape and mold the molten glass portions G received therein into the glass parisons, which are basically partially-formed glass containers, or some other preform shape. Each blank mold 20 may be a constituent portion of the blank side 18 of each of the forming machines 16. The forming machines 16 can be disposed on and/or coupled to a machine bed 26.

The molten glass handling system 14 includes a molten glass feeder 28, which fluidly communicates with and may be coupled to an upstream glass-containing vessel (not shown), such as a furnace or forehearth, and fashions molten glass received from the glass-containing vessel into the discrete portions of molten glass G. One or more outlets (not separately shown) of the glass feeder 28 are centered about one or more feeder axes F along which the discrete portions of molten glass G are delivered from the feeder 28. The feeder axes F may be aligned vertically, with gravity. Although not separately shown, the glass feeder 28 may include a bowl that may include a bottom orifice plate and a reciprocal plunger disposed within the bowl for controllably discharging one or more streams of molten glass through one or more orifices defined in the orifice plate. In this example, the orifices constitute the outlets of the glass feeder 28, and more than one orifice may be defined in the orifice plate, thus providing the glass feeder 28 with more than one outlet. The glass feeder 28 may also include one or more gob cutters 30 located external to and underneath the bowl for shearing the discharged stream(s) of molten glass into the individual discrete portion(s) of molten glass G. The cutters 30 may be shears, one or more lasers, or any other device(s) suitable to cut streams of molten glass into the discrete portions of molten glass G.

The molten glass handling system 14 may also include a cullet reject chute 31 for removing hot cullet. The cullet reject chute 31 may be disposed on and/or coupled to the machine bed 26 between the forming machines 16. The cullet reject chute 31 may be used for disposing of molten glass streams or gobs that fall or drop from the glass feeder 28. The chute 31 may be in communication with downstream cullet handling trenches and/or other equipment, typically located in a basement below the forming machines.

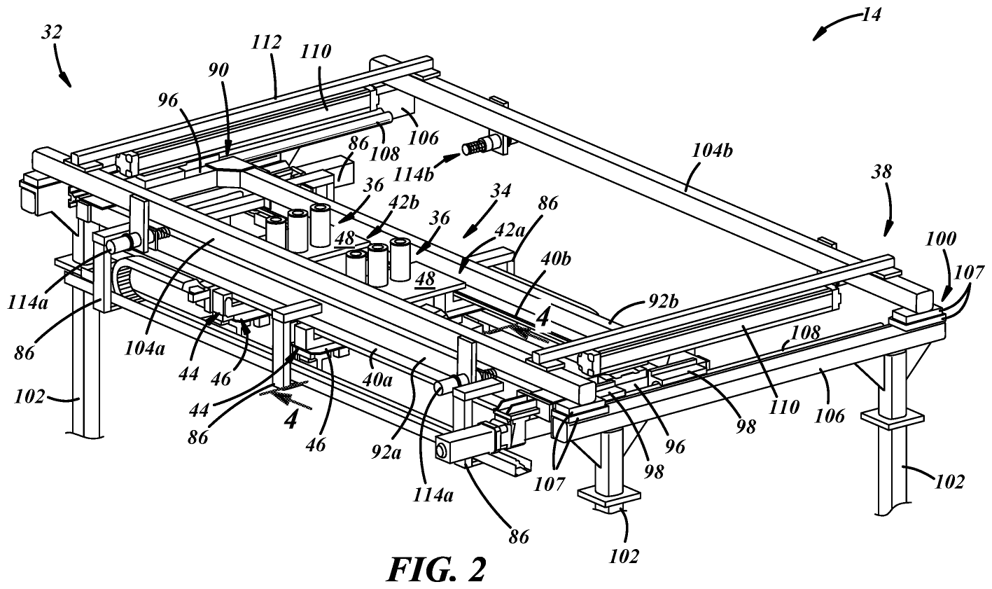

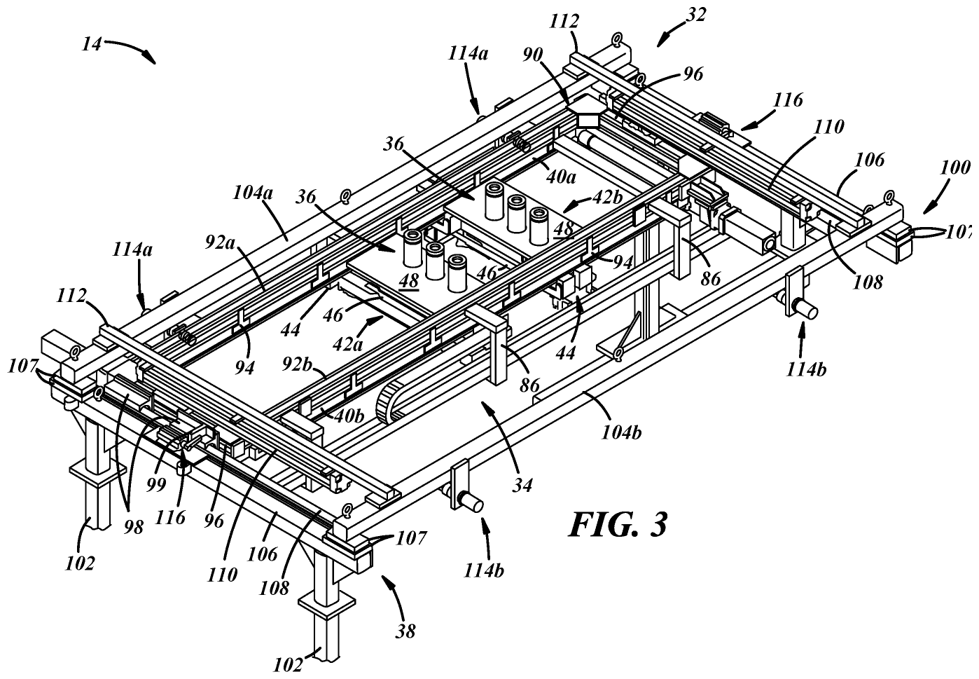

With additional reference to FIGS. 2 and 3, the molten glass handling system 14 also includes a molten glass transport system 32, which may include a gantry 34 to move molten glass transport cups 36 between, to, and from, the feeder axes F (FIG. 1) and the blank mold axes A (FIG. 1), and a superstructure 38 that may carry the gantry 34 in an elevated position above the glass forming system 12 (FIG. 1) as will be described further herein below. In the illustrated embodiment, the gantry 34 may include rails 40a,b spaced laterally apart from one another and establishing a cup transport path P (FIG. 1) extending longitudinally over the forming machines 16 (FIG. 1), and molten glass transporters or cup carriages 42a,b that extend laterally between and are translatably coupled to the rails 40a,b. Each of the cup carriages 42a,b is thus supported at opposite ends to each of the rails 40a,b and is movable back and forth along the cup transport path P to carry the transport cups 36. In other embodiments, the rails 40a,b need not be part of a gantry per se and could be stand-alone components or portions of some other material handling system. The rails 40a,b may be hollow rails, for example, extruded rails that may be composed of aluminum. The transporters or cup carriages 42a,b may be configured as disclosed in a co-assigned U.S. Application having attorney docket number 19720, the entire contents of which are incorporated herein by reference.

The rails 40a,b may extend beyond a lengthwise extent of the glass forming machines 16 to establish at least one cup carriage parking station S (FIG. 1) and preferably two cup carriage parking stations S as will be further described below. The glass feeder 28 (FIG. 1) feeds the discrete molten glass portions G to the transport cups 36 that define one or more cavities (not separately shown) configured to contain the molten glass portions G dispensed from the glass feeder 28 for transport to the glass forming system 12, preferably surrounded by a cushion of air to prevent heat transfer from the portion of molten glass G to the cups 36. Although not separately shown, each of the transport cups 36 may include a conduit, which defines the cavity of the cup 36, and a closure below the conduit that is movable with respect to the conduit. In this way, each of the transport cups 36 can receive a charge of molten glass G along a respective feeder axis F. retain the charge of molten glass G as the cup 36 is moved along the cup transport path P. and dispense the charge of molten glass G from the cup 36 by allowing the charge G to fall out of the conduit along a respective blank mold axis A.

The cup carriages 42a,b are configured to carry the transport cups 36 back-and-forth along the rails 40a,b between the glass feeder 28 and the forming machines 16 of the glass forming system 12. In one specific example, the first cup carriage 42a is brought beneath the glass feeder 28 and the transport cups 36 of the first cup carriage 42a receive discrete portions of molten glass G. The first cup carriage 42a with its transport cups 36 is then translated away from the glass feeder 28 in one direction along the cup transport path P to a corresponding one of the forming machines 16 (a first forming machine) where the discrete portions of molten glass G carried by the cups 36 are dropped into the blank molds 20 of the forming machine 16 along the blank mold loading axes A. After the transport cups 36 of the first cup carriage 42a receive their discrete portions of molten glass G from the glass feeder 28 and the first cup carriage 42a is translated toward the forming machine 16, the second cup carriage 42b is brought beneath the glass feeder 28 and the transport cups 36 of the second cup carriage 42b receive discrete portions of molten glass G. The second cup carriage 42b with its transport cups 36 is then translated away from the glass feeder 28 in a second direction along the cup transport path P opposite the first direction to a corresponding one of the forming machines 16 (a second forming machine) where the discrete portions of molten glass G carried by the cups 36 are dropped into the blank molds 20 of the forming machine 16 along the blank mold loading axes A. After the transport cups 36 of the second cup carriage 42b receive their discrete portions of molten glass G from the glass feeder 28 and are translated toward the forming machine 16, the first cup carriage 42a and its associated transport cups 36 is returned to the glass feeder 28 so that the cups 36 can receive subsequent portions of molten glass G.

The cup carriages 42a,b are illustrated carrying three transport cups 36 but can be configured to carry one, two, or any suitable quantity of transport cups 36. The carriages 42a,b may include, with reference again to FIGS. 2 and 3, carriage trucks or carts 44 translatably coupled to the rails 40a,b as will be described in further detail below, and carriage frames 46 fastened, welded, or otherwise coupled to the carriage carts 44 and extending laterally between the carriage carts 44 and the rails 40a,b. More specifically, each of the carriages 42a,b may include at least one cart 44 on either side of each of the carriage frames 46 and, as illustrated, may include two longitudinally spaced carts 44 on each side of each carriage frame 46 for a total of four carts 44 per carriage 42a,b. The transport cups 36 are carried by the carriage frames 46, and the carriages 42a,b may further include carriage shields 48 carried by the carriage frames 46 to protect the carriages 42a,b from molten glass and/or shear spray from the glass feeder 28. In the illustrated embodiment, the carriages 42a,b may be suspended from the rails 40a,b as discussed below.

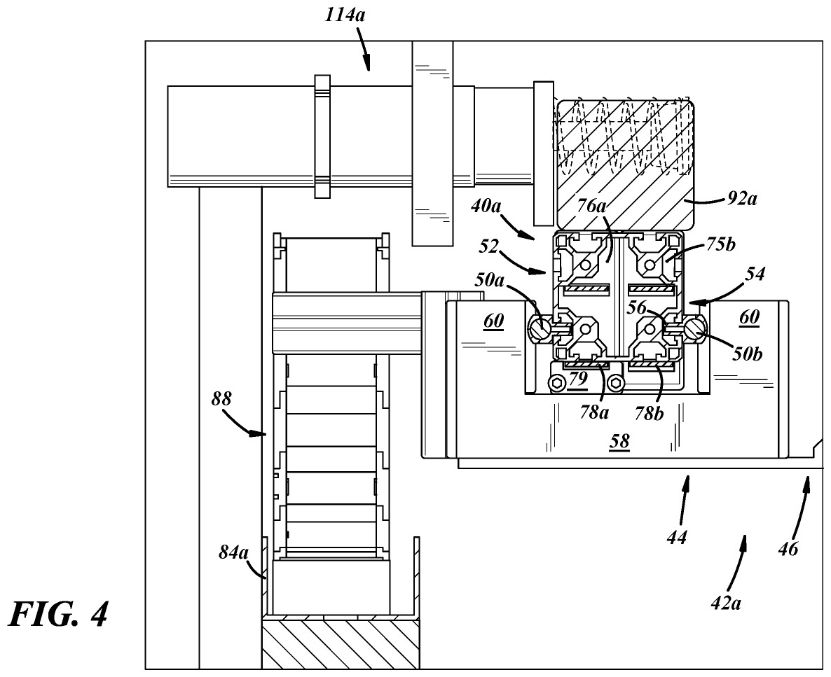

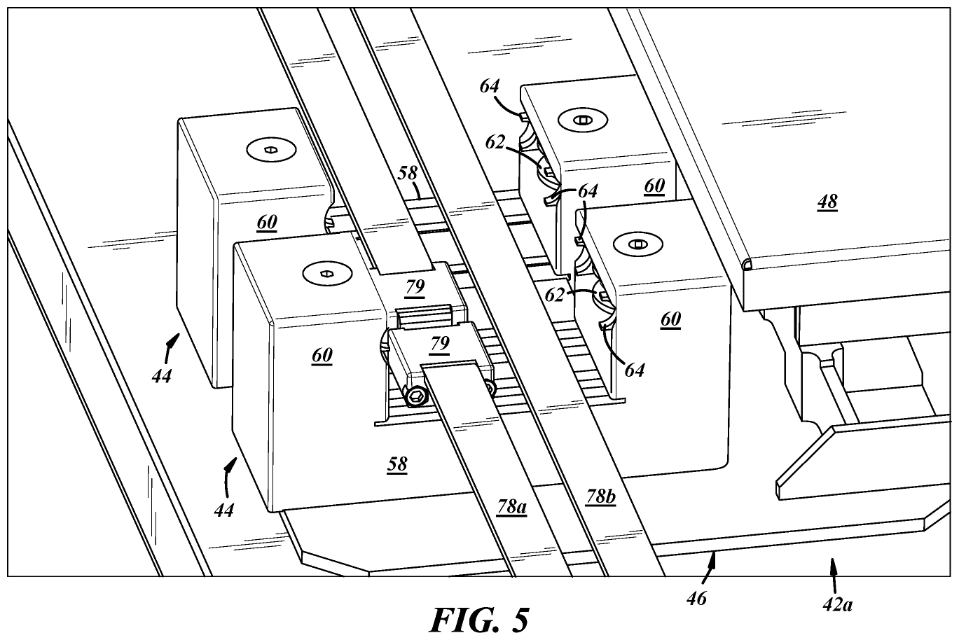

With reference now to FIG. 4, each of the rails 40a,b (only 40a shown in FIG. 4) may include outboard and inboard guide rods 50a,b extending longitudinally along corresponding outboard and inboard sides 52, 54 of the rails 40a,b. The guide rods 50a,b may be coupled to the rails 40a,b via intermediate retainers 56 that may be fastened, clipped, or otherwise coupled to the rails 40a,b. The carriage carts 44 may include bases 58 and legs 60 extending upwardly from the bases 58 and coupled to the corresponding sides 52, 54 of the rails 40a,b. The bases 58 of the carriage carts 44 may be located below the rails 40a,b, such that the carriage carts 44 may straddle the rails 40a,b from below the rails 40a,b. With reference to FIG. 5, the legs 60 may rotatably carry one or more rollers 62 to rotatably ride on the guide rods 50a,b (FIG. 4), and rod retainers 64 to facilitate retention of the carts 44 to the guide rods 50a,b.

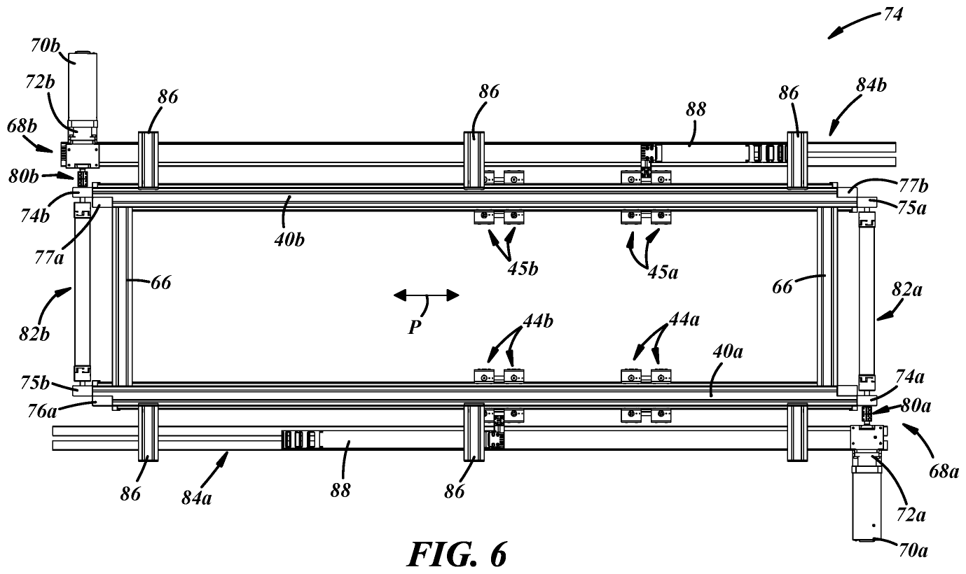

With reference now to FIG. 6, the gantry 34 also may include cross-members 66 spaced apart and extending transversely to the cup transport path P and extending between and fastened or otherwise coupled to the rails 40a,b. Also, the rails 40a,b may have staggered ends to accommodate two dual drivetrains such that the gantry 34 may be a dual gantry, for example, including two drivetrains 68a,b. A first drivetrain 68a may be coupled to a first set of first carts 44a along a first one of the rails 40a and to a second set of the first carts 45a along a second one of the rails 40b. Conversely, a second drivetrain 68b may be coupled to a first set of second carts 44b along the first one of the rails 40a and to a second set of second carts 45b along the second one of the rails 40b.

More specifically, the gantry 34 may be a belt-driven dual gantry, wherein the drivetrains 68a,b may include rotary actuators that may include prime movers 70a,b (e.g. servo motors) and gearboxes 72a,b coupled to the prime movers 70a,b. The drivetrains 68a,b also may include outboard drive pulleys 74a,b mounted to corresponding outboard drive portions of the rails 40a,b and having drive housings establishing drive belt paths through or below the rails 40a,b (depending on drive direction) and drive members such as internal gears or cogs (not separately shown) carried by the housings and drivingly coupled to the gearboxes 72a,b via couplings 80a,b. The drivetrains 68a,b also may include inboard drive pulleys 75a,b mounted to corresponding inboard drive portions of the rails 40a,b and having drive housings establishing drive belt paths through or below the rails 40a,b (depending on drive direction) and drive members such as internal gears or cogs (not separately shown) carried by the housings and drivingly coupled to driveshafts 82a,b driven through the outboard drive pulleys 74a,b. The drivetrains 68a,b further may include outboard driven pulleys 76a,b coupled to corresponding outboard driven portions of the rails 40a,b and having driven housings establishing driven belt paths through or below the rails 40a,b (depending on drive direction) and driven members such as internal gears or cogs (not separately shown) carried by the housings. The drivetrains 68a,b further may include inboard driven pulleys 77a,b coupled to corresponding inboard driven portions of the rails 40a,b and having driven housings establishing driven belt paths through or below the rails 40a,b (depending on drive direction) and driven members such as internal gears or cogs (not separately shown) carried by the housings.

The drivetrains 68a,b additionally may include belts 78a,b (FIGS. 4-5) extending along the belt paths of the housings of the drive pulleys 74a,b and extending around and engaged to the drive members of the drive pulleys 74a,b and extending around and engaged to the driven members of the driven pulleys 76a,b. The belts 78a,b (FIGS. 4-5) are coupled to the carriages 42a via the carts 44, which may carry belt couplings 79 to which the belts 78a,b may be releasably coupled. The belts 78a,b, carts 44, and couplings 79 may be obtained from Macron Dynamics (Croydon, PA) as part of a rail or gantry system. Of course, although not shown, the second rail 40b may include its own first and second belts extending therethrough and coupled to corresponding portions of the first and second drivetrains 68a,b. The belts 78a,b (FIGS. 4-5) may extend along external bottom surfaces of the rails 40a,b and may extend through hollow portions of the rails 40a,b in a continuous loop.

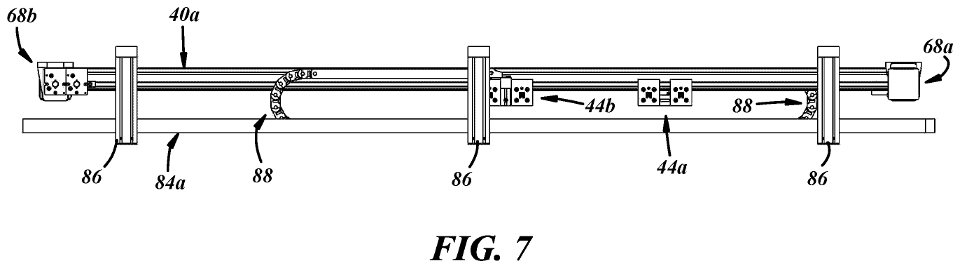

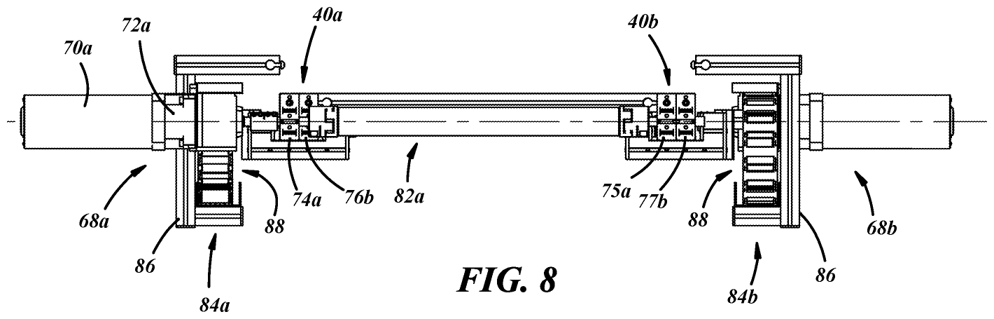

With reference now to FIGS. 6-8, although the below-described reinforcement frame is omitted for clarity, utility tracks 84a, 84b may suspended therefrom at a location below the rails 40a,b by any suitable brackets 86 to carry a cable chain 88. In turn, the cable chain 88 carries utilities like electrical power cables, electrical control wires, pneumatic supply hoses or tubes, and the like, that are coupled to the carriages at one end and to any suitable utility couplings at another end (not shown). As shown in FIGS. 2 and 3, the utility tracks 84a, 84b may be suspended by a reinforcement frame 90 that may be coupled to the gantry 34. The reinforcement frame 90 may include for instance, reinforcement beams 92a, 92b spaced apart and coupled to the rails 40a,b of the gantry 34, for example, via brackets 94 (FIG. 3), which may be upside-down T-shaped brackets that may be fastened, welded, or otherwise coupled to the rails 40a,b and reinforcement beams 92a, 92b. The reinforcement frame 90 also may include reinforcement cross-members 96 spaced apart and extending transversely to the cup transport path P (FIG. 1) and extending between and coupled to the reinforcement beams 92a, 92b in any suitable manner. The beams 92a, 92b and cross-members 96 may be extruded aluminum components. The utility tracks 84a,b may be coupled to the reinforcement beams 92a,b via the brackets 86 and any suitable fasteners. A connection between the brackets 86 and the beams 92a,b of the reinforcement frame 90 can be seen in FIGS. 2 and 3.

With continued reference to FIGS. 2 and 3, the superstructure 38 of the molten glass transport system 32 may movably carry the gantry 34 to facilitate movement of the gantry 34 from a production position to a parked position spaced away from the production position, for example, to facilitate access to the feeder 28 above. The superstructure 38 may include the reinforcement frame 90 coupled to the gantry 34, bearing blocks 98 coupled to the reinforcement cross-members 96, and a fixed frame 100 coupled to and movably carrying the reinforcement frame 90. The fixed frame 100 may include vertical supports 102 that may be used to support the fixed frame 100 on the machine bed 26 (FIG. 1), or may be supported by a factory floor independent of the machine bed 26 (FIG. 1). Also, the fixed frame 100 may include fixed beams 104a, 104b laterally spaced apart, and fixed cross-members 106 longitudinally spaced apart and extending transversely between and coupled to the fixed beams by fasteners, welding, or in any other suitable manner and via shims 107 if desired. The fixed frame 100 also may include bearing shafts 108 extending along the fixed cross-members 106 and coupled thereto in any suitable manner and carrying the bearing blocks 98 to guide movement of the belt-driven gantry 34 transversely with respect to the cup transport path P (FIG. 1).

The superstructure 38 also may include gantry actuators 110 extending transversely between the fixed beams 104a,b, and coupled to the fixed beams 104a,b, for example by being coupled to and suspended from actuator brackets 112 extending between and mounted on the fixed beams 104a,b. The actuators 110 are coupled to the gantry 34 to move the gantry 34 transversely with respect to the cup transport path P (FIG. 1). For example, the actuators 110 may include drive members (not separately shown) that are translatable along a predominant longitudinal axis of the actuator 110, transverse to the carriage path P, and that are coupled to driven members (not separately shown) coupled to the reinforcement frame 90, more specifically, to the cross-members 96 thereof. The superstructure 38 further may include cushions 114a, 114b coupled to the fixed beams 104a,b and engageable with the reinforcement beams 92a,b to cushion movement of the gantry 34 with respect to the fixed frame 100.

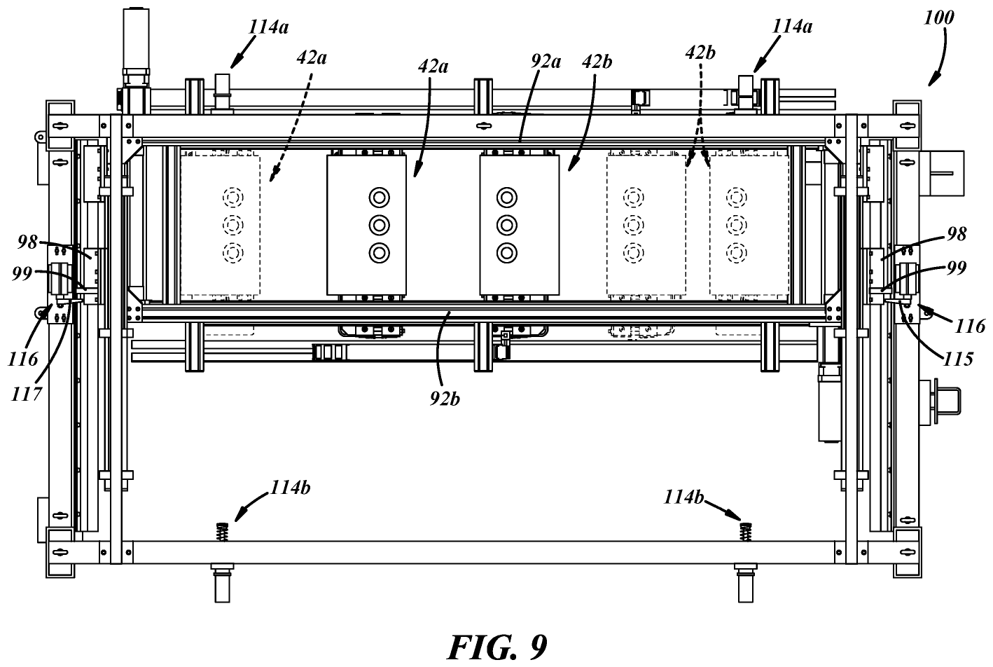

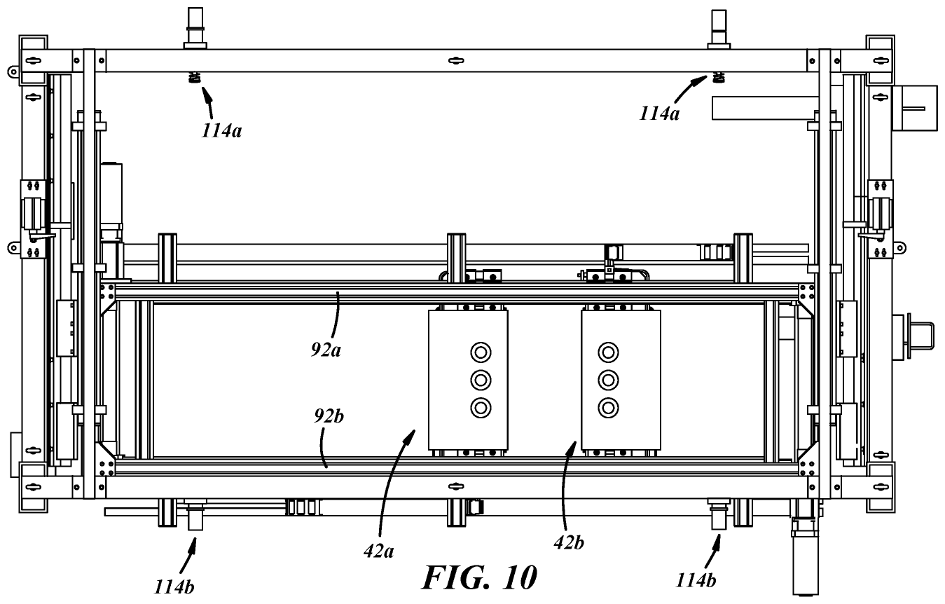

With reference now to FIGS. 9 and 10, the superstructure 38 additionally may include locks 116 operatively coupled between the fixed frame 100 and the reinforcement frame 90. For example, the locks 116 may be fixed to the fixed cross-members 106 and may have movable portions 117 selectively engageable to corresponding fixed portions 99 of the bearing blocks 98 or some portion of the reinforcement frame 90. The movable portions 117 of the locks 116 may be moved out of engagement with the corresponding fixed portions 99 of the bearing blocks 98 to allow the actuators 110 to be activated to move the gantry 34 from its production position (FIG. 9) to its parked position (FIG. 10).

With continued reference to FIG. 9, the molten glass transport system 32 is shown in its production position, with the second carriage 42b shown in the common gob loading position and the first carriage 42a shown in a first gob unloading position. The first carriage 42a is also shown in a first parked position in dashed lines. The second carriage 42b is also shown in a second gob unloading position shown in dashed line and in a second parked position in dashed lines. With reference to FIG. 10, the first carriage 42a is shown in the common gob loading position, and the second carriage 42b is shown in the second gob unloading position, albeit in the parked position of the gantry 34.

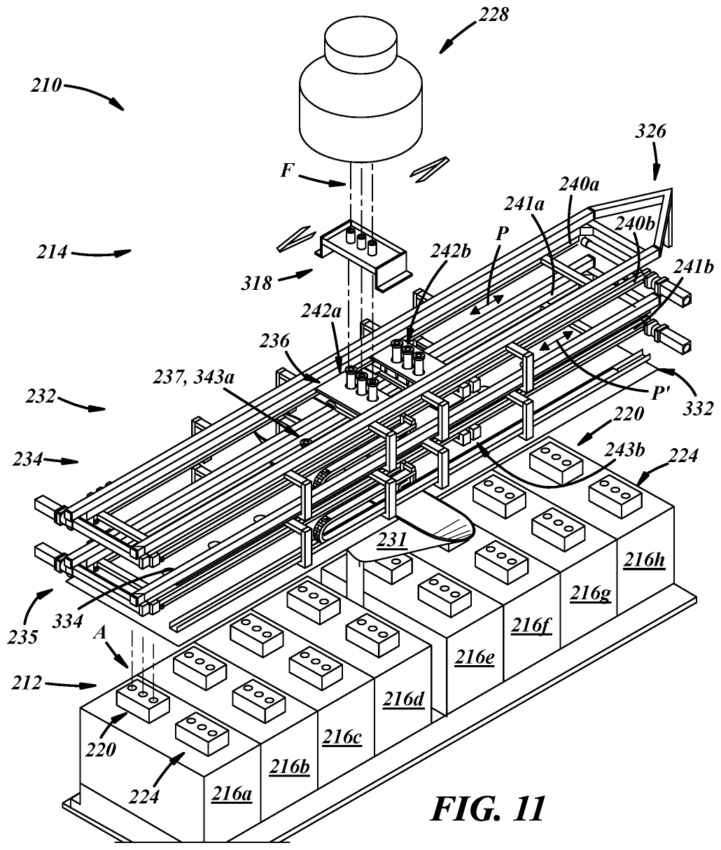

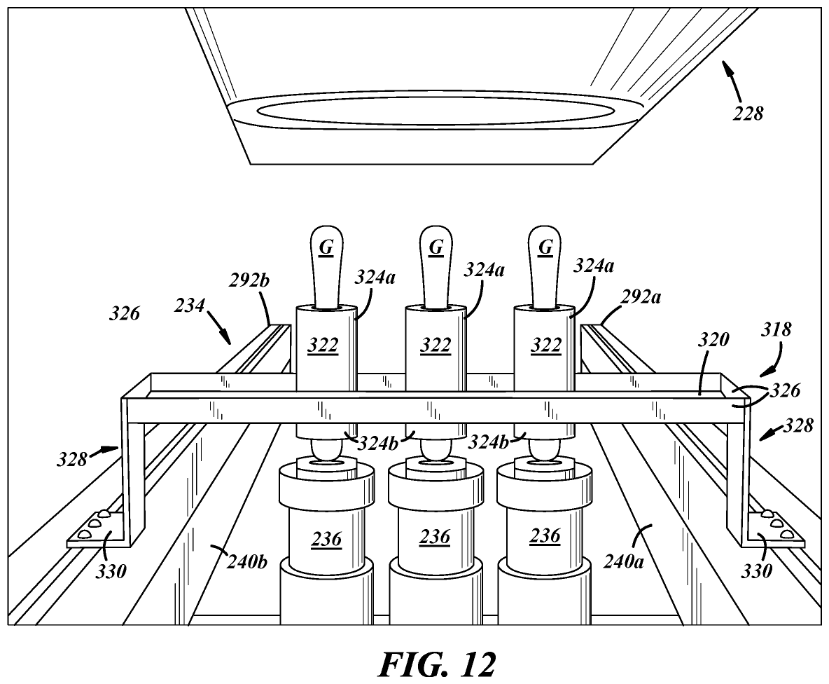

FIGS. 11 and 12 show another illustrative embodiment of a glass manufacturing system 210. This embodiment is similar in many respects to the embodiment of FIGS. 1-10 and like numerals among the embodiments generally designate like or corresponding elements throughout the several views of the drawing figures. Accordingly, the descriptions of the embodiments are incorporated into one another, and description of subject matter common to the embodiments generally may not be repeated here. With reference to FIG. 11, the glass manufacturing system 210 comprises a glass forming system 212 and a molten glass handling system 214. The illustrated glass forming system 212 includes a plurality of forming machines 216a-h each having one or more blank molds 220, each of which has a corresponding opening centered about a blank mold loading axis A, and one or more blow molds 224. The molten glass handling system 214 includes a molten glass feeder 228, establishing one or more feeder axes F along which the discrete portions of molten glass G are delivered from the feeder 228, a cullet reject chute 231 for removing hot cullet, and a molten glass transport system 232.

The transport system 232 may include an upper gantry 234 to move one or more upper transport cups 236 between, to, and from, the feeder axes F and the blank mold axes A, and a lower gantry 235 to move one or more lower transport cups 237 between, to, and from, the feeder axes F and the blank mold axes A. In the illustrated embodiment, the upper gantry 234 may include rails 240a,b spaced laterally apart from one another and establishing an upper cup transport path P. and upper cup carriages 242a,b that extend laterally between and are translatably coupled to the rails 240a,b such that the cup carriages 242a,b are supported at both ends by the rails 240a,b and are movable back and forth along the upper cup transport path P between and to the one or more feeder axes F and the blank mold loading axes A. Similarly, the lower gantry 235 includes additional lower rails 241a,b spaced laterally apart from one another and establishing an additional lower cup transport path P′ vertically adjacent to the upper cup transport path P. The lower gantry 235 also includes additional lower cup carriages 243a,b that extend laterally between and are translatably coupled to the additional lower rails 241,b such that the cup carriages 243a,b are supported at both ends by the rails 241a,b and are movable back and forth along the additional lower cup transport path P′ between and to the one or more feeder axes F and the blank mold loading axes A.

The transport system 232 further includes a protective shield 318 vertically located between the glass feeder 228 and the blank molds 216a-h and laterally located between upper rails 240a,b of the upper gantry 234. The shield 318 may also be used with the embodiment illustrated in FIGS. 1-10 and, for example, may be mounted to the superstructure frame 100 below the beams 104a,b and cross members 106 of the superstructure frame 100. The shield 318 includes a base wall 320 including one or more apertures (not shown) therethrough coaxial with the one or more glass feeder axes, and conduits 322 extending away from the base wall 320 through the apertures. More specifically, with reference to FIG. 12, the conduits 322 may extend above and/or below the base wall 320 and may include upper portions 324a above the base wall 320 and/or lower portions 324b below the base wall 320. Additionally, the shield 318 may include sidewalls 326 extending upwardly away from the base wall 320 to establish a containment tray. The shield 318 may include legs 328 extending downwardly and coupled to the gantry 234, for example, via feet 330 that may be fastened, welded, or otherwise coupled to reinforcement beams 292a,b of the gantry 234, and establishing a vertical height of the base wall 320 with respect to the rails 240a,b and/or with respect to tops of the cups 236. The shield 318 may protect the transport cups 236 from shear spray, lubricants, or any other potential contaminants from falling into the transport cups 236 and interfering with the quality of the molten glass being transported to the blank molds, for example, by contaminating transporter mechanisms, clogging pores of graphite material of the transport cups, and producing unexpected boil off gas in the cups.

In addition to the protective shield 318, the system 210 also may include a shield 332 disposed between the lower gantry 235 and the glass forming system 212. The shield 332 may protect personnel from gobs improperly discharged from a gob feeder 228 and protect the forming machines 216a-h from shear spray, lubricants, or any other potential contaminants from falling into the blank molds 220 and interfering with the quality of parisons produced by the blank molds. The shield 332 may include apertures 334 coaxially aligned with the blank molding axes A to allow the charges of molten glass to fall therethrough.

A method for transporting molten glass may be carried out using the above-described systems, or any other suitable system(s) (the reference numerals of those systems are omitted here for readability). The method includes moving a first cup carriage along a cup transport path between spaced apart rails to a common loading position below a glass feeder, wherein the first cup carriage includes a first transport cup, and receiving molten glass from the glass feeder along a feeder axis between the rails into the first transport cup of the first cup carriage. The method also includes moving the first cup carriage to a first unloading position along the cup transport path to locate the first transport cup over a first blank mold having a first blank mold loading axis, and dispensing the molten glass between the rails from the first transport cup into the first blank mold along the first blank mold loading axis. The method additionally may include returning the first cup carriage along the cup transport path to the common loading position and repeating the aforementioned steps.

The method also may include moving a second cup carriage along the cup transport path between the spaced apart rails to the common loading position below the glass feeder, wherein the second cup carriage includes a second transport cup, and receiving molten glass from the glass feeder along the feeder axis between the rails into the second transport cup. The method further may include moving the second cup carriage to a second unloading position along the cup transport path to locate the second transport cup over a second blank mold having a second blank mold loading axis, and dispensing the molten glass between the rails from the second transport cup into the second blank mold along the second blank mold loading axis. The method additionally may include returning the second cup carriage along the cup transport path to the common loading position and repeating the aforementioned steps. Also, the first and second cup carriages may be movable along a common plane, or the first cup carriage may be movable along the cup transport path in a first plane and the second cup carriage may be movable along a second cup transport path in a second plane spaced apart from the first plane. The method further may include the carriages being suspended from the spaced apart rails. The method also may include moving one or both of the cup carriages to one or more parked positions located outboard of the blow molds along the cup transport path, and/or transporting the spaced apart rails along a transverse direction transverse to the cup transport path.

Additionally, the operation of the first and second cup carriages may be synchronized or otherwise coordinated, as follows. The step of moving the second cup carriage along the cup transport path to the common loading position may be carried out while carrying out the step of moving the first cup carriage to the first unloading position, and/or the step of receiving molten glass from the glass feeder along the feeder axis between the rails into the second transport cup may be carried out while carrying out the step of dispensing the molten glass between the rails from the first transport cup into the first blank mold is being carried out. Conversely, the step of moving the first cup carriage along the cup transport path to the common loading position may be carried out while carrying out the step of moving the second cup carriage to the second unloading position, and/or the step of receiving molten glass from the glass feeder along the feeder axis between the rails into the first transport cup may be carried out while carrying out the step of dispensing the molten glass between the rails from the second transport cup into the second blank mold.

As used in herein, the terminology “for example,” “e.g.,” for instance,” “like,” “such as,” “comprising,” “having,” “including,” and the like, when used with a listing of one or more elements, is to be construed as open-ended, meaning that the listing does not exclude additional elements. Also, as used herein, the term “may” is an expedient merely to indicate optionality, for instance, of a disclosed embodiment, element, feature, or the like, and should not be construed as rendering indefinite any disclosure herein. Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. The present disclosure is intended to embrace all such embodiments and modifications of the subject matter of this application, and equivalents thereto, as fall within the broad scope of the accompanying claims.

1. A method for transporting molten glass, comprising:
(a) moving a first cup carriage along a cup transport path between spaced apart rails to a common loading position below a glass feeder, wherein the first cup carriage includes a first transport cup;
(b) receiving molten glass from the glass feeder along a feeder axis between the rails into the first transport cup of the first cup carriage;
(c) moving the first cup carriage to a first unloading position along the cup transport path to locate the first transport cup over a first blank mold having a first blank mold loading axis; and
(d) dispensing the molten glass between the rails from the first transport cup into the first blank mold along the first blank mold loading axis.

2. The method for transporting molten glass of claim 1, wherein the moving step also includes the first carriage being suspended from the spaced apart rails.

3. The method for transporting molten glass of claim 1, further comprising:
(e) moving a second cup carriage along the cup transport path between the spaced apart rails to the common loading position below the glass feeder, wherein the second cup carriage includes a second transport cup;
(f) receiving molten glass from the glass feeder along the feeder axis between the rails into the second transport cup;
(g) moving the second cup carriage to a second unloading position along the cup transport path to locate the second transport cup over a second blank mold having a second blank mold loading axis; and
(h) dispensing the molten glass between the rails from the second transport cup into the second blank mold along the second blank mold loading axis.

4. The method for transporting molten glass of claim 3, further comprising:
(i) returning the first cup carriage along the cup transport path to the common loading position and repeating steps (b) through (d); and
(j) returning the second cup carriage along the cup transport path to the common loading position and repeating steps (f) through (h).

5. The method for transporting molten glass of claim 1, further comprising:
moving the first cup carriage to a first parked position located outboard of the first blow mold along the cup transport path.

6. The method for transporting molten glass of claim 1, further comprising:
transporting the spaced apart rails along a transverse direction transverse to the cup transport path.

7. The method for transporting molten glass of claim 1, wherein the first and second cup carriages are movable along a common plane.

8. The method for transporting molten glass of claim 1, wherein the first cup carriage is movable along the cup transport path in a first plane and the second cup carriage is movable along a second cup transport path in a second plane spaced apart from the first plane.

9. A glass manufacturing system, comprising:
a glass forming system, including:
glass forming machines arranged adjacent to one another, and each including blank molds having blank mold loading axes, and blow molds spaced apart from the blank molds; and
a molten glass handling system including:
a glass feeder to feed molten glass along one or more feeder axes offset from the blank mold loading axes, and
a molten glass transport system to transport the molten glass to the blank molds of the glass forming machines of the glass forming system, and including:
rails spaced laterally apart from one another and establishing a cup transport path, and
cup carriages extending laterally between the rails and movable back and forth along the cup transport path between, to, and from the one or more feeder axes and the blank mold loading axes, and including one or more transport cups to receive the molten glass from the glass feeder along the one or more feeder axes and dispense the molten glass to the blank molds along the blank mold loading axes.

10. The glass manufacturing system set forth in claim 9, wherein the cup carriages are suspended from the rails.

11. The glass manufacturing system set forth in claim 9, wherein the molten glass transport system also includes
a fixed frame, and
at least one actuator operatively coupled between the fixed frame and the rails,
wherein the rails are movably carried by the fixed frame along a rail path transverse to the cup transport path and the at least one actuator is actuatable to move the rails, and the cup carriages and the transport cups, away from the blank molds to facilitate access to the glass feeder.

12. The glass manufacturing system set forth in claim 11, wherein the fixed frame includes
fixed beams corresponding to the rails,
fixed cross-members coupled to the fixed beams, and
bearing rods coupled to the fixed cross-members.

13. The glass manufacturing system set forth in claim 9, wherein the molten glass transport system also includes
additional rails spaced laterally apart from one another and establishing an additional cup transport path vertically adjacent to the cup transport path, and
additional cup carriages extending laterally between the additional rails and movable back and forth along the additional cup transport path between and to the one or more feeder axes and the blank mold loading axes.

14. The glass manufacturing system set forth in claim 9, wherein the rails extend beyond a lengthwise extent of the blank molds of the glass forming machines to establish at least one cup carriage parking station.

15. The glass manufacturing system set forth in claim 9, further comprising:
a protective shield located between the glass feeder and the blank molds, extending laterally between the rails, and including
a base wall including one or more apertures therethrough coaxial with one or more glass feeder axes, and
conduits extending away from the base wall through the apertures.

16. A molten glass transport system, comprising:
rails spaced laterally apart from one another and establishing a cup transport path; and
cup carriages movable back and forth along the cup transport path of the rails, and including
carriage carts translatably coupled to the rails,
carriage frames extending laterally between the rails and coupled to the carriage carts, and
transport cups carried by the carriage frames.

17. The molten glass transport system of claim 16, further comprising rail cross-members extending laterally between the rails.

18. The molten glass transport system of claim 16, wherein the carriage carts are suspended from the rails.

19. The molten glass transport system of claim 18, further comprising a belt-driven gantry that includes the rails, rail cross-members between the rails, and the carriage carts.

20. The molten glass transport system of claim 19, wherein the belt-driven gantry includes drive belts extending along external bottom surfaces of the rails.

21. The molten glass transport system of claim 16, further comprising:
reinforcement beams coupled to the rails to reinforce the rails against flexure.

22. The molten glass transport system of claim 21, further comprising utility tracks suspended from the reinforcement beams at a location below the rails.

23. The molten glass transport system of claim 21, further comprising reinforcement cross-members coupled to the reinforcement beams.

24. The molten glass transport system of claim 23, further comprising:
a fixed frame including
fixed beams spaced laterally apart, and
fixed cross-members spaced apart and extending between and coupled to the fixed beams,
bearing shafts coupled to and extending along the fixed cross-members, and
bearing blocks fixed to the reinforcement cross-members and movably carried by the bearing shafts such that the rails are movable transversely with respect to the cup transport path.

25. The molten glass transport system of claim 16, further comprising:
a protective shield extending between the rails and including an aperture therethrough.

26. The molten glass transport system of claim 25, wherein the protective shield further includes a base wall including the aperture therein and a conduit extending away from the base wall above and below the base wall and having a vertical passage concentric with the aperture.

27. A molten glass transport system, comprising:
a gantry, including
gantry rails spaced laterally apart and establishing a cup transport path;
gantry cross-members spaced apart and extending transversely to the cup transport path and extending between and coupled to the gantry rails; and
drivetrains; and
cup carriages carried by the gantry and movable along the cup transport path on the rails, and including:
carriage carts spaced laterally apart and coupled to the rails,
carriage frames coupled to and extending between the carriage carts, and
transport cups carried by the carriage frames.

28. The molten glass transport system of claim 27, further comprising:
a superstructure including
a reinforcement frame that includes
reinforcement beams spaced apart and coupled to the rails, and
reinforcement cross-members spaced apart and extending transversely to the cup transport path and extending between and coupled to the reinforcement beams; and
bearing blocks coupled to the reinforcement cross-members.

29. The molten glass transport system of claim 27, wherein the superstructure further includes
a fixed frame including
fixed beams spaced apart, and
fixed cross-members spaced apart and extending transversely between and coupled to the fixed beams; and
bearing shafts coupled to and extending along the fixed cross-members and carrying the bearing blocks to guide movement of the gantry transversely with respect to the cup transport path.

30. The molten glass transport system of claim 27, wherein the superstructure further includes
gantry actuators extending transversely between the fixed beams, and coupled to the fixed beams and to the gantry to move the gantry transversely with respect to the cup transport path.

31. The molten glass transport system of claim 27, wherein the superstructure further includes
cushions coupled to the fixed beams and engageable with the reinforcement beams to cushion movement of the gantry with respect to the fixed frame.

32. A molten glass transport system, comprising:
rails spaced laterally apart from one another and establishing a cup transport path; and
cup carriages suspended from the rails and movable back and forth along the cup transport path of the rails.

33. The molten glass transport system of claim 32, wherein the cup carriages include
carriage carts translatably coupled to and suspended from the rails,
carriage frames extending laterally between the rails at a location below the rails and coupled to the carriage carts, and
transport cups carried by the carriage frames.
